(19) United States
(12) Patent Application Publication
(10) Pub. No.: US 2020/0308377 A1
(43) Pub. Date: Oct. 1, 2020

(54) VULCANIZABLE COMPOSITIONS CONTAINING HYDROGENATED NITRILE RUBBER, VULCANIZATES PRODUCED THEREFROM AND USE THEREOF

(71) Applicant: ARLANXEO DEUTSCHLAND GMBH, Dormagen (DE)

(72) Inventors: Ulrich FRENZEL, Dormagen (DE); Susanna LIEBER, Kaiserslautern (DE)

(73) Assignee: ARLANXEO DEUTSCHLAND GMBH, Dormagen (DE)

(21) Appl. No.: 16/639,689

(22) PCT Filed: Aug. 13, 2018
(86) PCT No.: PCT/EP2018/071855

§ 371 Date: Jun. 18, 2020

(30) Foreign Application Priority Data
Aug. 16, 2017 (EP) 17186346.7

(51) Int. Cl. C08L 19/00; C08L 9/02

(52) U.S. Cl. CPC C08L 19/00; C08K 3/04; C08L 9/02

(57) ABSTRACT

The present invention relates to vulcanizable compositions comprising hydrogenated nitrile rubber, unsilanized mineral filler, less than 20 phr carbon black and a peroxidic crosslinker. The invention also relates to the production of such vulcanizable compositions, and also to vulcanizates that are produced therefrom and to the use thereof as mouldings that are in contact with acidic media comprising either organic or inorganic acids, preferably gaskets, belts and hoses that are in contact with blow-by or EGR gas or the condensate thereof.

This application is a 371 of PCT/EP2018/071855, filed Aug. 13, 2018, which claims foreign priority benefit under 35 U.S.C. § 119 of European Patent Application No. 17186346.7, filed Aug. 16, 2017, the disclosures of which are incorporated herein by reference.

The present invention relates to the use of a vulcanizable composition comprising hydrogenated nitrile rubber, unsilanized mineral filler, less than 20 phr carbon black and a peroxidic crosslinker for production of vulcanizates that are in contact with blow-by gas, EGR gas or motor oil comprising blow-by gas constituents. The invention also relates to the production of such vulcanizable compositions, and also to vulcanizates that are produced therefrom and to the use thereof as mouldings that are in contact with acidic media comprising either organic or inorganic acids, preferably gaskets, belts and hoses that are in contact with blow-by or EGR gas or the condensate thereof.

In reciprocating-piston internal combustion engines, an oil-containing, aggressive leakage gas, called blow-by gas, occurs in the crankcase. More specifically, blow-by gases are a mixture of exhaust gases, oil, uncombusted fuel and water. The recycling thereof into the combustion process is legally stipulated worldwide, and is effected in what are called closed crankcase ventilation systems. Rubber components are frequently used here, for example hoses or gaskets, made of HNBR- or FKM-based vulcanizates.

The organic and inorganic acids, oils and fuel residues present in the blow-by gas or condensate thereof lead to swelling and ageing of the HNBR vulcanizates used, which means that the proper function of the rubber components produced therefrom is no longer assured.

There are similar occurrences in the recycling of exhaust gas into the combustion chamber, called EGR (exhaust gas recirculation). Here too, the rubber components are subjected to significant stresses as a result of the fuel residues present in the recycled exhaust gases or condensates thereof, and organic and inorganic acids.

The properties of an HNBR vulcanizate are dependent on the interaction of the constituents of the vulcanizable composition. As well as the hydrogenated nitrile rubber as base constituent, the further fillers in particular are crucial. Most HNBR-containing compositions comprise carbon blacks since these have an excellent and controllable reinforcing effect and constant product properties, provide protection from harmful UV rays and are additionally relatively inexpensive, and hence reduce the cost of the rubber component.

Additionally known are HNBR-containing compositions comprising mineral fillers such as silicates and oxides. Among other documents, EP-A-1 357 156 discloses treating, i.e. silanizing, oxidic or silicatic compounds with organosilicon compounds, in order, by means of this treatment, to reinforce the bond between inorganic filler and the organic polymer used in filler-reinforced elastomers and hence to improve the properties of the fillers in the polymers.

The prior art discloses a number of using HNBR-based vulcanizable compositions and vulcanizates thereof.

EP-A-3 100 780 discloses, in paragraph [0029], using HNBR as a possible material as well as other elastomers as a sealing element of the valve sealing body of a crankcase ventilation system in contact with blow-by gas. No further details of the composition of the sealing element are disclosed.

DE102008033267A1 discloses vulcanizates composed of vulcanizable compositions comprising 100 parts by weight of hydrogenated nitrile rubber, 6 parts by weight of zinc oxide, 15 parts by weight of silica, 15 parts by weight of carbon black and 7 parts by weight of a peroxide compound. There is no disclosure of compositions having high proportions of unsilanized mineral fillers of 40 to 200 parts by weight.

DE102005062075A1 discloses vulcanizates composed of vulcanizable compositions comprising 100 parts by weight of hydrogenated nitrile rubber, 2 parts by weight of zinc oxide, 60 parts by weight of carbon black and 8 parts by weight of a peroxide compound. There is no disclosure of compositions having high proportions of unsilanized mineral fillers of 40 to 200 parts by weight and small amounts of carbon black of less than 20 parts by weight. The applicant's patent application PCT/EP2017/051238 that was unpublished at the filing date discloses vulcanizable compositions comprising HNBR, carbon black or silanized mineral filler and peroxide as crosslinker. The explicitly disclosed compositions 1 and 3 include high amounts of carbon black (N990). Compositions 2 and 4 include a silanizing agent (Silquest). There is no disclosure of the use of the vulcanizates produced from these compositions for components, especially gaskets, that are in contact with blow-by gases.

The brochure “Non-black fillers in HNBR (peroxide cured)” from Hoffmann Mineral (published in 2008) discloses compositions comprising HNBR, silanized mineral filler (Aktisil VM 56, i.e. a silica-kaolinite mixture silanized with vinylsilane) or 50 or 100 phr carbon black and peroxide, and 50 phr sodium aluminium silicate.

The product brochure “Introduction to Therban” from Bayer, section 4.13 (published in 2000), discloses compositions comprising HNBR with 39 wt % of acrylonitrile (ACN), small amounts of less than 70 parts by weight of unsilanized mineral fillers such as Vulkasil N, Hi-Sil 532EP, Silene 732D and peroxide.

WO-A-2010/030747 discloses compositions comprising HNBR, mineral filler (HI-SIL® 532 EP; HYCITE® 713) and silanizing agent (STRUKTOL® SCA 972).

What is common to all the prior art documents is that there is no disclosure of vulcanizable compositions of hydrogenated nitrile rubbers having a combination of unsilanized mineral filler, less than 20 phr carbon black and peroxide for production of vulcanizates in contact with blow-by gas, EGR gas or motor oil comprising blow-by gas constituents.

The vulcanizates disclosed in the prior art are unsatisfactory with regard to the volume swelling of the vulcanizates in contact with mixtures of organic and inorganic acids, for example sulfuric acid, nitric acid, acetic acid or formic acid, as may be present in the blow-by gas.

The problem addressed by the present invention was therefore that of providing vulcanizable compositions and vulcanizates thereof based on hydrogenated nitrile rubbers for use in contact with blow-by gas, EGR gas or motor oil comprising blow-by gas constituents, wherein the vulcanizates have improved stability to blow-by gas or EGR gas, i.e. reduced volume swelling on ageing in compositions comprising fuel residues, organic and inorganic acids, and/or the vulcanizates have high elongation at break.

It has now been found that, surprisingly, compositions comprising a hydrogenated nitrile rubber, an unsilanized mineral filler, for example Polestar® 200R or Silfit® Z91, and small amounts of carbon black of less than 20 phr, after peroxidic crosslinking, lead to vulcanizates which, by comparison with the prior art HNBR-based vulcanizates, have improved stability to mixtures of organic and inorganic acids and especially blow-by gas, and are thus suitable for use in contact with blow-by gas, EGR gas or motor oil comprising blow-by gas constituents.

The invention therefore provides for the use of a vulcanizable composition for production of a vulcanizate in contact with blow-by gas, EGR gas or motor oil comprising blow-by gas constituents, wherein the vulcanizable composition comprises
(a) 100 parts by weight of at least one hydrogenated nitrile rubber,
(b) 40 to 200 parts by weight, preferably 50 to 150 parts by weight, more preferably 70 to 120 parts by weight, of at least one unsilanized mineral filler,
(c) 0 to less than 20 parts by weight of carbon black, preferably 0 to less than 10 parts by weight of carbon black, more preferably 0 to 5 parts by weight of carbon black, most preferably 0 parts by weight of carbon black, and
(d) 0.5 to 20 parts by weight of at least one peroxide compound.

This profile of properties is not possible in the case of use of the vulcanizable compositions of hydrogenated nitrile rubbers known to date, comprising either carbon black in an amount of 20 phr or more and/or silanized mineral fillers.

Preference is given to the use of vulcanizable compositions comprising
(a) 100 parts by weight of at least one hydrogenated nitrile rubber,
(b) 40 to 200 parts by weight, preferably 50 to 150 parts by weight, more preferably 70 to 120 parts by weight, of at least one unsilanized mineral silicatic or oxidic filler,
(c) 0 to less than 20 parts by weight of carbon black, preferably 0 to 10 parts by weight of carbon black, more preferably 0 to 5 parts by weight of carbon black,
(d) 0.5 to 20 parts by weight, preferably 2 to 10 parts by weight, of at least one peroxide compound, and
(e) 0 to 15 parts by weight, preferably 1 to 10 parts by weight, more preferably 2 to 7 parts by weight, of basic silicate having a pH in water (5 wt % in water) measured according to DIN ISO 787/9 of greater than 7.

Particular preference is given to the use of vulcanizable compositions comprising
(a) 100 parts by weight of at least one hydrogenated nitrile rubber,
(b) 40 to 200 parts by weight, preferably 50 to 150 parts by weight, more preferably 70 to 120 parts by weight, of precipitated silica, fumed silica, kaolin, calcined kaolin, diatomaceous earth, Neuburg siliceous earth, calcined Neuburg siliceous earth, feldspar, alumina or mixtures thereof,
(c) 0 to less than 20 parts by weight of carbon black, preferably 0 to 10 parts by weight of carbon black, more preferably 0 to 5 parts by weight of carbon black,
(d) 0.5 to 20 parts by weight, preferably 2 to 10 parts by weight, of at least one peroxide compound, and
(e) 0 to 15 parts by weight, preferably 1 to 10 parts by weight, more preferably 2 to 7 parts by weight, of basic silicate having a pH in water (5 wt % in water) measured according to DIN ISO 787/9 of greater than 7.

Very particular preference is given to the use of vulcanizable compositions comprising
(a) 100 parts by weight of at least one hydrogenated nitrile rubber,
(b) 40 to 200 parts by weight, preferably 50 to 150 parts by weight, more preferably 70 to 120 parts by weight, of unsilanized calcined kaolin comprising 50 to 60 wt %, preferably 55 wt %, of SiO₂ and 35 to 45 wt %, preferably 41 wt %, of Al₂O₃, based on the total amount of component (b),
(c) 0 to 5 parts by weight of carbon black,
(d) 0.5 to 20 parts by weight, preferably 2 to 10 parts by weight, of at least one peroxide compound, more preferably dicumyl peroxide, tert-butyl cumyl peroxide, bis(tert-butylperoxyisopropyl)benzene, di-tert-butyl peroxide, 2,5-dimethylhexane 2,5-dihydroperoxide, 2,5-dimethylhex-3-yne 2,5-dihydroperoxide or dibenzoyl peroxide, and
(e) 1 to 10 parts by weight, preferably 2 to 7 parts by weight, of sodium aluminium silicate having a pH in water (5 wt % in water) measured according to DIN ISO 787/9 of 11.3±0.7, a content of volatile constituents measured according to DIN ISO 787/2 of 5.5±1.5 and a surface area (BET) measured according to ISO 9277 of 65±15.

It is a feature of the vulcanizable compositions according to the invention that the vulcanizates produced therefrom have low volume swelling in contact with blow-by gases and higher elongation at break compared to vulcanizates containing 20 phr or more carbon black or silanized mineral filler.

The vulcanizable composition according to the invention comprises, as component (a), at least one hydrogenated nitrile rubber.

Hydrogenated nitrile rubbers:

Hydrogenated nitrile rubbers (HNBRs) in the context of this application are understood to mean co- and/or terpolymers based on at least one conjugated diene and at least one α,β-unsaturated nitrile and optionally further copolymerizable monomers, where all or some of the copolymerizable diene units have been hydrogenated.

“Hydrogenation” or “hydrogenated” in the context of this application is understood to mean a conversion of the double bonds originally present in the nitrile rubber to an extent of at least 50%, preferably at least 85%, more preferably at least 95%.

The α,β-unsaturated nitrile used may be any known α,β-unsaturated nitrile, preference being given to (C₃-C₅)-α,β-unsaturated nitriles such as acrylonitrile, methacrylonitrile, ethacrylonitrile or mixtures thereof. Acrylonitrile is particularly preferred.

Any conjugated diene can be used. Preference is given to using (C₄-C₆) conjugated dienes. Particular preference is given to 1,3-butadiene, isoprene, 2,3-dimethylbutadiene, piperylene or mixtures thereof. Especially preferred are 1,3-butadiene and isoprene or mixtures thereof. Very particular preference is given to 1,3-butadiene.

The proportions of conjugated diene and α,β-unsaturated nitrile in the hydrogenated nitrile rubbers can be varied within wide ranges. The proportion of, or of the sum of, the conjugated dienes is typically in the range from 40 to 90 wt %, preferably in the range from 50 to 80 wt %, based on the overall polymer. The proportion of, or of the sum of, the α,β-unsaturated nitriles is typically in the range from 10 to 60 wt %, preferably in the range from 20 to 50 wt %, based on the overall polymer. The additional monomers may be present in amounts in the range from 0.1 to 40 wt %, preferably in the range from 1 to 30 wt %, based on the overall polymer. In this case, corresponding proportions of the conjugated diene(s) and/or of the α,β-unsaturated nitrile(s) are replaced by the proportions of the additional monomers, where the proportions of all monomers in each case add up to 100 wt %.

In a preferred embodiment, the content of repeat acrylonitrile units in the hydrogenated nitrile rubber (a) in the vulcanizable composition according to the invention is 10 to 50 wt %, preferably 17 to 43 wt % and more preferably 20 to 36 wt %, based on the total amount of hydrogenated nitrile rubber (a).

The preparation of such hydrogenated nitrile rubbers that are suitable for the vulcanizable compositions according to the invention is sufficiently familiar to the person skilled in the art.

The initial preparation of the nitrile rubbers by copolymerization of the aforementioned monomers has been described extensively in the literature (e.g. Houben-Weyl, Methoden der Organischen Chemie [Methods of Organic Chemistry], vol. 14/1, Georg Thieme Verlag Stuttgart 1961).

The subsequent hydrogenation of the above-described nitrile rubbers to hydrogenated nitrile rubber can be effected in the manner known to the person skilled in the art.

It is possible in principle to conduct the hydrogenation of nitrile rubbers using homogeneous or heterogeneous hydrogenation catalysts.

As described in WO-A-01/77185, it is possible, for example, to conduct the reaction with hydrogen using homogeneous catalysts, for example that known as the “Wilkinson” catalyst ((PPh₃)₃RhCl) or others. Processes for hydrogenating nitrile rubber are known. Rhodium or titanium are typically used as catalysts, but it is also possible to use platinum, iridium, palladium, rhenium, ruthenium, osmium, cobalt or copper, either as the metal or else preferably in the form of metal compounds (see, for example, U.S. Pat. No. 3,700,637, DE-A-25 39 132, EP-A-134 023, DE-A-35 41 689, DE-A-35 40 918, EP-A-298 386, DE-A-35 29 252, DE-A-34 33 392, U.S. Pat. Nos. 4,464,515 and 4,503,196).

Suitable catalysts and solvents for a hydrogenation in homogeneous phase are described hereinafter and are also known from DE-A-25 39 132 and EP-A-0 471 250.

The selective hydrogenation can be achieved, for example, in the presence of a rhodium catalyst. It is possible to use, for example, a catalyst of the general formula

(R¹ₘB)ₗRhXₙ

in which
R¹ are the same or different and are a C₁-C₈ alkyl group, a C₄-C₈ cycloalkyl group, a C₆-C₁₅ aryl group or a C₇-C₁₅ aralkyl group,
B is phosphorus, arsenic, sulfur or a sulfoxide group S═O,
X is hydrogen or an anion, preferably halogen and more preferably chlorine or bromine,
l is 2, 3 or 4,
m is 2 or 3 and
n is 1, 2 or 3, preferably 1 or 3.

Preferred catalysts are tris(triphenylphosphine)rhodium (I) chloride, tris(triphenylphosphine)rhodium(II) chloride and tris(dimethyl sulfoxide)rhodium(III) chloride, and also tetrakis(triphenylphosphine)rhodium hydride of the formula ((C₆H₅)₃P)₄RhH and the corresponding compounds in which the triphenylphosphine has been replaced fully or partly by tricyclohexylphosphine. The catalyst can be used in small amounts. An amount in the range of 0.01 to 1 wt %, preferably in the range of 0.03 to 0.5 wt % and more preferably in the range of 0.1 to 0.3 wt %, based on the weight of the polymer, is suitable.

It is typically advisable to use the catalyst together with a cocatalyst which is a ligand of the formula R¹ₘB where R¹, m and B are each as defined above for the catalyst. Preferably, m is 3, B is phosphorus and the R¹ radicals may be the same or different. Preference is given to cocatalysts having trialkyl, tricycloalkyl, triaryl, triaralkyl, diarylmonoalkyl, diarylmonocycloalkyl, dialkylmonoaryl, dialkylmonocycloalkyl, dicycloalkylmonoaryl or dicycloalkylmonoaryl radicals.

Examples of cocatalysts can be found, for example, in U.S. Pat. No. 4,631,315. A preferred cocatalyst is triphenylphosphine. The cocatalyst is used preferably in amounts within a range of 0.3 to 5 wt %, more preferably in the range of 0.5 to 4 wt %, based on the weight of the nitrile rubber to be hydrogenated.

Preferably, in addition, the weight ratio of the rhodium catalyst to the cocatalyst is in the range from 1:3 to 1:55, more preferably in the range from 1:5 to 1:45. Based on 100 parts by weight of the nitrile rubber to be hydrogenated, in a suitable manner, 0.1 to 33 parts by weight of the cocatalyst, preferably 0.5 to 20 and most preferably 1 to 5 parts by weight, especially more than 2 but less than 5 parts by weight, of the cocatalyst are used.

The practical performance of such hydrogenations is sufficiently well-known to those skilled in the art, for example from U.S. Pat. No. 6,683,136. It is typically effected by contacting the nitrile rubber to be hydrogenated with hydrogen in a solvent such as toluene or monochlorobenzene at a temperature in the range from 100° C. to 150° C. and a pressure in the range from 50 bar to 150 bar for 2 hours to 10 hours.

In the case of use of heterogeneous catalysts for preparation of hydrogenated carboxylated nitrile rubbers by hydrogenation of the corresponding carboxylated nitrile rubbers, the catalysts are typically supported catalysts based on palladium.

In an alternative embodiment of the invention, the Mooney viscosity (ML 1+4 measured at 100° C.) of the hydrogenated nitrile rubber (a) used or, if two or more hydrogenated nitrile rubbers (a) are used, of the overall mixture of all hydrogenated nitrile rubbers (a) is typically within a range from 10 to 120, preferably within a range from 15 to 100. The Mooney viscosity is determined here to ASTM Standard D 1646.

In an alternative embodiment of the invention, the hydrogenated nitrile rubber according to the invention typically has a content of residual double bonds (RDB) of 10% or less, preferably of 7% or less, more preferably of 0.9% or less.

In an alternative embodiment of the invention, the hydrogenated nitrile rubbers usable in the vulcanizable composition according to the invention typically have a glass transition temperature of lower than −15° C., preferably lower than −20° C., more preferably lower than −25° C.

Some of the hydrogenated nitrile rubbers (a) mentioned are commercially available, but are also obtainable in all cases by production methods accessible to the person skilled in the art via the literature. Examples of hydrogenated nitrile rubbers are fully and partly hydrogenated nitrile rubbers having acrylonitrile contents in the range of 20 to 50 wt % (Therban® range from LANXESS Deutschland GmbH and the Zetpol® range from Nippon Zeon Corporation or the Zhanber® range from Zannan). Examples of hydrogenated butadiene/acrylonitrile/acrylate polymers are the Therban® LT series from LANXESS Deutschland GmbH, for example Therban® LT 2157 and Therban® LT 2007. One example of carboxylated hydrogenated nitrile rubbers is the Therban® XT series from LANXESS Deutschland GmbH. An example of hydrogenated nitrile rubbers having low Mooney viscosities and therefore improved processibility is a product from the Therban® AT series, for example Therban® AT 3404.

The hydrogenated nitrile rubber, as well as repeat units of at least one unsaturated nitrile and at least one conjugated diene, may contain one or more further copolymerizable monomers in the form of carboxylic acids or carboxylic esters. These are hydrogenated carboxylated nitrile rubbers (also abbreviated as HXNBR).

Suitable copolymerizable carboxylic acids are mono- or dicarboxylic acids which have 3 to 18 carbon atoms and are α,β-unsaturated, and esters thereof. Preferred α,β-unsaturated carboxylic acids are acrylic acid, methacrylic acid, itaconic acid, fumaric acid, maleic acid, crotonic acid and mixtures thereof.

Esters of the α,β-unsaturated carboxylic acids having 3 to 18 carbon atoms preferably include the alkyl esters and the alkoxyalkyl esters of the aforementioned carboxylic acids. Preferred esters of the α,β-unsaturated carboxylic acids having 3 to 18 carbon atoms are methyl acrylate, ethyl acrylate, butyl acrylate, 2-ethylhexyl acrylate and octyl acrylate, C₁-C₈-alkoxy-PEG (meth)acrylate having 1 to 8 repeat ethylene glycol units. Preferred alkoxyalkyl esters are methoxyethyl acrylate and ethoxyethyl acrylate, and mixtures thereof.

Preferred esters are α,β-ethylenically unsaturated dicarboxylic acid monoesters, for example
alkyl monoesters, especially C₄-C₁₈-alkyl monoesters, preferably n-butyl, tert-butyl, n-pentyl or n-hexyl monoesters, more preferably mono-n-butyl maleate, mono-n-butyl fumarate, mono-n-butyl citraconate, mono-n-butyl itaconate;
alkoxyalkyl monoesters, especially C₄-C₁₈-alkoxyalkyl monoesters, preferably C₄-C₁₂-alkoxyalkyl monoesters,
hydroxyalkyl monoesters, especially C₄-C₁₈-hydroxyalkyl monoesters, preferably C₄-C₁₂-hydroxyalkyl monoesters,
cycloalkyl monoesters, especially C₅-C₁₈-cycloalkyl monoesters, preferably C₆-C₁₂-cycloalkyl monoesters, more preferably monocyclopentyl maleate, monocyclohexyl maleate, monocycloheptyl maleate, monocyclopentyl fumarate, monocyclohexyl fumarate, monocycloheptyl fumarate, monocyclopentyl citraconate, monocyclohexyl citraconate, monocycloheptyl citraconate, monocyclopentyl itaconate, monocyclohexyl itaconate and monocycloheptyl itaconate,
alkylcycloalkyl monoesters, especially C₆-C₁₂-alkylcycloalkyl monoesters, preferably C₇-C₁₀-alkylcycloalkyl monoesters, more preferably monomethylcyclopentyl maleate and monoethylcyclohexyl maleate, monomethylcyclopentyl fumarate and monoethylcyclohexyl fumarate, monomethylcyclopentyl citraconate and monoethylcyclohexyl citraconate; monomethylcyclopentyl itaconate and monoethylcyclohexyl itaconate;
aryl monoesters, especially C₆-C₁₄-aryl monoesters, preferably monoaryl maleate, monoaryl fumarate, monoaryl citraconate or monoaryl itaconate, more preferably monophenyl maleate or monobenzyl maleate, monophenyl fumarate or monobenzyl fumarate, monophenyl citraconate or monobenzyl citraconate, monophenyl itaconate or monobenzyl itaconate or mixtures thereof,
unsaturated polyalkyl polycarboxylates, for example dimethyl maleate, dimethyl fumarate, dimethyl itaconate or diethyl itaconate; or
α,β-ethylenically unsaturated carboxylic esters containing amino groups, for example dimethylaminomethyl acrylate or diethylaminoethyl acrylate.

The proportions of conjugated diene and α,β-unsaturated nitrile in the HXNBR polymers may vary within wide ranges. The proportion of, or of the sum of, the conjugated dienes is typically in the range from 15 to 90 wt %, preferably in the range from 40 to 75 wt %, based on the overall polymer. The proportion of, or of the sum of, the α,β-unsaturated nitrile(s) is typically 0.1 to 60 wt %, preferably 8 to 50 wt %, based on the overall polymer. The additional monomers are present in amounts of 0.1 to 65 wt %, preferably 15 to 50 wt %, based on the overall polymer. The proportions of all monomers in each case add up to 100 wt %.

Thus, the hydrogenated carboxylated nitrile rubbers comprise a hydrogenated carboxylated nitrile rubber HXNBR based on at least one unsaturated nitrile, at least one conjugated diene and at least one further termonomer containing carboxyl and/or carboxylate groups, where at least 50% of the double bonds originally present in the XNBR are saturated.

Examples of suitable HXNBRs include hydrogenated carboxylated nitrile rubbers based on an XNBR composed of butadiene and acrylonitrile and acrylic acid and/or methacrylic acid and/or fumaric acid and/or maleic acid and/or the methyl, ethyl, propyl, isopropyl, n-butyl, isobutyl, n-hexyl and/or 2-ethylhexyl monoesters of fumaric acid and/or maleic acid and/or the methyl, ethyl, propyl, isopropyl, n-butyl, isobutyl, n-hexyl and/or 2-ethylhexyl esters of acrylic acid and/or methacrylic acid.

Hydrogenated carboxylated nitrile rubbers are obtainable in various ways:

For example, it is possible to graft an HNBR with compounds containing carboxyl groups.

They can also be obtained by hydrogenation of carboxylated nitrile rubbers (XNBR). Hydrogenated carboxylated nitrile rubbers of this kind are described, for example, in WO-A-01/77185.

As well as the at least one hydrogenated nitrile rubber (a), further elastomers may additionally also be present. Further elastomers are present in a weight ratio of 1:5 to 5:1 relative to the hydrogenated nitrile rubbers. In a preferred embodiment, no further elastomers are present aside from the hydrogenated nitrile rubber (a).

Component (b)—Unsilanized Mineral Filler

Component (b) of the vulcanizable composition according to the invention is an unsilanized mineral filler.

The term “silanized” is understood by the person skilled in the art to mean the chemical attachment of a silane compound to a surface. The attachment is effected by condensation reactions between hydrolysable groups of the silanes used and chemical groups on the filler surface.

The term “mineral filler” is understood by the person skilled in the art to mean what are called light-coloured mineral fillers that come from a natural origin, for example silicates, oxides, hydroxides or kaolin, or are synthesized by particular methods, for example silica.

Preferred unsilanized mineral fillers (b) are unsilanized mineral silicatic or oxidic fillers.

Unsilanized mineral silicatic fillers used may be silicate, kaolin, mica, kieselguhr, diatomaceous earth, talc, wollastonite, aluminium silicate, zeolite, precipitated silica or clay, or else silicates, including in the form of glass beads, ground glass splinters (ground glass), glass fibres or glass weaves.

Unsilanized mineral oxidic fillers used may be alumina, transition metal oxides, zirconium dioxide or titanium dioxide.

However, the addition of high amounts of ZnO leads to unwanted increase in hardness, which reduces the fields of application of the vulcanizates.

In a preferred embodiment of the vulcanizable composition according to the invention, the proportion of ZnO in the unsilanized mineral filler is not more than 20 parts by weight, preferably not more than 10 parts by weight and more preferably not more than 5 parts by weight, based on 100 parts by weight of HNBR. In a particularly preferred embodiment, the vulcanizable composition according to the invention does not include any ZnO.

The silicates may also take the form of mixed oxides with other metal oxides, for example oxides of Ca, Ba, Zn, Zr or Ti.

Particularly preferred unsilanized mineral fillers (b) in the context of this invention are precipitated silica, fumed silica, kaolin, calcined kaolin, diatomaceous earth, Neuburg siliceous earth (Sillitin®, Sillikolloid®), calcined Neuburg siliceous earth (Silfit®), feldspar or alumina.

Very particularly preferred unsilanized mineral fillers (b) are calcined kaolins having a specific surface area (N₂ surface area) of less than 10 m²/g, containing at least 40 wt % of silicate (SiO₂) and at least 10 wt % of alumina (Al₂O₃), based on the total amount of component (b), or mixtures of amorphous and cryptocrystalline silica and lamellar kaolinite having a BET surface area of 8 m²/g, an SiO₂ content of 86 wt %, an Al₂O₃ content of 13 wt %, based on the total amount of unsilanized filler (b), and a pH of 6.5.

The values reported here in the description for the specific surface area of the fillers are BET values, i.e. values measured according to DIN ISO 9277.

One example of a preferred unsilanized mineral silicatic filler (b) is SILFIT® Z 91 (commercially available from Hoffmann Mineral). SILFIT Z 91 is a natural mixture of amorphous and cryptocrystalline silica and lamellar kaolinite that has been subjected to a thermal treatment. SILFIT Z 91 has a BET surface area of 8 m²/g, an SiO₂ content of 86 wt %, an Al₂O₃ content of 13 wt % and a pH of 6.5.

In a further preferred embodiment, the unsilanized mineral silicatic filler (b) is a hydrophilic fumed silica containing >99.8 wt % of SiO₂ having a specific surface area (BET) of 175 to 225 m²/g and a pH of 4.1±0.4, for example Aerosil® 200 (commercially available from Evonik Industries).

In a further preferred embodiment, the unsilanized mineral silicatic filler (b) is a precipitated silica, for example Vulkasil® N (commercially available from LANXESS Deutschland GmbH).

In a further preferred embodiment, the unsilanized mineral silicatic filler (b) is amorphous silica consisting of spherical silicon dioxide particles that are produced via a gas phase condensation, for example Sidistar® (commercially available from Elkem AS).

In a further preferred embodiment, the unsilanized mineral silicatic filler (b) is diatomaceous earth or calcined diatomaceous earth, for example Celite® 350.

Further preferably, component (b) is calcined kaolin containing 40 to 70 wt % of SiO₂ and 30 to 60 wt % of Al₂O₃, having a pH of 6.0 to 7.0±0.5 and a surface area (BET) of 8 to 9 m²/g.

More preferably, component (b) is calcined kaolin containing 50 to 60 wt % of SiO₂, 35 to 45 wt % of Al₂O₃, having a pH of 6.4 to 6.6±0.5 and a surface area (BET) of 8.3 to 8.7 m²/g.

Most preferably, component (b) is calcined kaolin containing 50 to 60 wt %, preferably 55 wt %, of SiO₂ and 35 to 45 wt %, preferably 41 wt %, of Al₂O₃, having a pH of 6.5±0.5 and a surface area (BET) of 8.5 m²/g. One example of a very particularly preferred component (b) is the calcined kaolin Polestar® 200R (commercially available from Imerys). Polestar® 200R is produced by heating ground kaolin to temperatures above 1000° C.

Likewise preferred are mixtures of the preferred components (b) listed here.

Component (b) is present in the vulcanizable compositions according to the invention in an amount of 40 to 200 parts by weight, preferably in an amount of 50 to 150 parts by weight, more preferably 70 to 120 parts by weight, based on 100 parts by weight of the hydrogenated nitrile rubbers (a).

Component (c)—Carbon Black

The compositions according to the invention contain less than 20 phr carbon black. As component (c), it is therefore possible to use only 0 to less than 20 phr carbon black as filler. Preference is given to using 0 to 10 phr, more preferably 0 to 5 phr, carbon black, most preferably 0 phr carbon black, as filler.

Compositions according to the invention without carbon black are thus the most preferred.

Component (d)—Peroxide Compound

At least one peroxide compound as crosslinking agent is used as component (d).

Suitable peroxide compounds (d) are, for example, the following peroxide compounds:

bis(2,4-dichlorobenzoyl) peroxide, dibenzoyl peroxide, bis(4-chlorobenzoyl) peroxide, 1,1-bis(tert-butylperoxy)-3,3,5-trimethylcyclohexane, tert-butyl perbenzoate, 2,2-bis(tert-butylperoxy)butene, 4,4-di-tert-butyl peroxynonylvalerate, dicumyl peroxide, 2,5-dimethyl-2,5-di(tert-butylperoxy)hexane, tert-butyl cumyl peroxide, 1,3-bis(tert-butylperoxyisopropyl)benzene, di-tert-butyl peroxide, 2,5-dimethyl-2,5-di(tert-butylperoxy)hexyne, tert-butyl hydroperoxide, hydrogen peroxide, methyl ethyl ketone peroxide, lauroyl peroxide, decanoyl peroxide, 3,5,5-trimethylhexanoyl peroxide, di(2-ethylhexyl) peroxydicarbonate, poly(tert-butyl peroxycarbonate), ethyl 3,3-di(tert-butylperoxy)butyrate, ethyl 3,3-di(tert-amylperoxy)butyrate, n-butyl 4,4-di(tert-butylperoxy)valerate, 2,2-di(tert-butylperoxy)butane, 1,1-di(tert-butylperoxy)cyclohexane, 3,3,5-trimethylcyclohexane, 1,1-di(tert-amylperoxy)cyclohexane, tert-butyl peroxybenzoate, tert-butyl peroxyacetate, tert-butyl peroxy-3,5,5-trim ethylhexanoate, tert-butyl peroxyisobutyrate, tert-butyl peroxy-2-ethylhexanoate, tert-butyl peroxypivalate, tert-amyl peroxypivalate, tert-butyl peroxyneodecanoate, cumyl peroxyneodecanoate, 3-hydroxy-1,1-dimethylbutyl peroxyneodecanoate, tert-butyl peroxybenzoate, tert-butyl peroxyacetate, tert-amyl peroxy-3,5,5-trimethylhexanoate, tert-butyl peroxyisobutyrate, tert-butyl peroxy-2-ethylhexanoate, cumyl peroxyneodecanoate, 3-hydroxy-1,1-dimethylbutyl peroxyneodecanoate, 2,5-dimethyl-2,5-di(tert-butylperoxy)hexyne 3-di-tert-amyl peroxide, 2,5-dimethyl-2,5-di(tert-butylperoxy)hexane, tert-amyl hydroperoxide, cumene hydroperoxide, 2,5-dimethyl-2,5-di(hydroperoxy)hexane, diisopropylbenzene monohydroperoxide and potassium peroxodisulfate.

The at least one peroxide compound (d) in the vulcanizable composition according to the invention is preferably an organic peroxide, especially dicumyl peroxide, tert-butyl cumyl peroxide, bis(tert-butylperoxyisopropyl)benzene, di-tert-butyl peroxide, 2,5-dimethylhexane 2,5-dihydroperoxide, 2,5-dimethylhex-3-yne 2,5-dihydroperoxide, dibenzoyl peroxide, bis(2,4-dichlorobenzoyl) peroxide, tert-butyl perbenzoate, butyl 4,4-di(tert-butylperoxy)valerate and/or 1,1-bis(tert-butylperoxy)-3,3,5-trimethylcyclohexane.

The peroxide compound (d) is present in the vulcanizable compositions according to the invention preferably in an amount of 0.5 to 20 parts by weight, more preferably in an amount of 2 to 10 parts by weight, based on 100 parts by weight of the hydrogenated nitrile rubbers (a).

Component (e)—Basic Silicate

The vulcanizable composition according to the invention may optionally comprise a basic silicate (e).

In the context of this invention, the term “basic silicate” represents silicates which, measured in a 5 wt % aqueous solution according to DIN ISO 787/9, have a pH of more than 7.

Component (e) is a basic silicate having a pH of more than 7, preferably having a pH of more than 8, more preferably having a pH of more than 8 to 12 and most preferably having a pH of 10.5 to 12, measured in a 5 wt % aqueous solution according to DIN ISO 787/9. One example of basic silicates having a pH of more than 7 is sodium aluminium silicate, available under the Vulkasil® A1 brand name from LANXESS.

Preferably, component (e) is a basic silicate having a pH of more than 8 from the group consisting of sodium aluminium silicate and sodium orthosilicate (Na₄SiO₄), sodium metasilicate (Na₂SiO₃), disodium disilicate (Na₂Si₂O₅), disodium trisilicate (Na₂Si₃O₇), more preferably sodium aluminium silicate.

More preferably, component (e) is a sodium aluminium silicate.

One example of a particularly preferred component (e) is the sodium aluminium silicates having the Zeolex® 23 brand name (commercially available from Huber) having a pH of 10 and a surface area (BET) of 80.

Most preferably, component (e) comprises sodium aluminium silicate having a pH in water (5 wt % in water) measured according to DIN ISO 787/9 of 11.3±0.7, a content of volatile constituents measured according to DIN ISO 787/2 of 5.5±1.5 and a surface area (BET) measured according to ISO 9277 of 65±15. One example of a very particularly preferred component (e) is the sodium aluminium silicate having the Vulkasil® A1 brand name (commercially available from LANXESS Deutschland GmbH).

Component (e) is present in the vulcanizable compositions according to the invention in an amount of 0 to 15 parts by weight, preferably in an amount of 1 to 10 parts by weight, based on 100 parts by weight of the hydrogenated nitrile rubbers (a).

In addition, the vulcanizable composition may comprise further rubber additives. Standard rubber additives include, for example: polymers not covered by the definition of component (a) according to the invention, filler-activators, plasticizers, processing auxiliaries, accelerators, co-agents, multifunctional crosslinkers, ageing stabilizers, antiozonants, antioxidants, mould release agents, scorch inhibitors, further stabilizers and antioxidants, dyes, fibres comprising organic and inorganic fibres and fibre pulps, vulcanization activators, and additional polymerizable monomers, dimers, trimers or oligomers.

Useful filler-activators especially include non-silane interface-active substances such as triethanolamine or ethylene glycols with molecular weights of 74 to 10 000 g/mol. The amount of filler-activators is typically 0.5 to parts by weight, based on 100 parts by weight of the hydrogenated nitrile rubbers (a).

Useful plasticizers include aromatic, naphthenic, paraffinic and synthetic plasticizers, for example thioesters, phthalic esters, aromatic polyethers, phosphoric esters such as tricresyl phosphate, sebacic esters such as dioctyl sebacate, low molecular weight polymeric polyesters, dioctyl adipate or trioctyl trimellitate. Plasticizers of this kind are typically used in dosages of 0 to 20 phr. Combinations of various plasticizers are likewise possible.

Useful ageing stabilizers are especially those which scavenge a minimum number of radicals in the peroxidic vulcanization. These are especially oligomerized 2,2,4-trimethyl-1,2-dihydroquinoline (TMQ), styrenized diphenylamine (DDA), octylated diphenylamine (OCD), cumylated diphenylamine (CDPA) or zinc salt of 4- and 5-methylmercaptobenzimidazole (ZMB2). In addition, it is also possible to use the known phenolic ageing stabilizers, such as sterically hindered phenols, or ageing stabilizers based on phenylenediamine. It is also possible to use combinations of the ageing stabilizers mentioned.

The ageing stabilizers are typically used in amounts of 0.1 to 5 parts by weight, preferably of 0.3 to 3 parts by weight, based on 100 parts by weight of the hydrogenated nitrile rubbers (a). More preferably, diphenylamines are used in a dosage of 1 to 2 phr.

Examples of useful mould release agents include: saturated or partly unsaturated fatty acids and oleic acids or derivatives thereof (in the form of fatty acid esters, fatty acid salts, fatty alcohols or fatty acid amides), and also products applicable to the mould surface, for example products based on low molecular weight silicone compounds, products based on fluoropolymers and products based on phenolic resins.

The mould release agents are used, for example, as a mixture constituent in amounts of 0.2 to 10 parts by weight, preferably 0.5 to 5 parts by weight, based on 100 parts by weight of the hydrogenated nitrile rubbers (a), or applied directly to the mould surface.

Reinforcement of the vulcanizates with glass strengthening elements according to the teaching of U.S. Pat. No. 4,826,721 is also possible, as is reinforcement with aromatic polyamides (Aramid®). This is necessary especially when the vulcanizable mixture according to the invention is used in belts.

The invention preferably also provides for the use of a vulcanizable composition for production of a vulcanizate in contact with blow-by gas, EGR gas or motor oil comprising blow-by gas constituents, wherein the vulcanizable composition comprises
(a) 100 parts by weight of at least one hydrogenated nitrile rubber,
(b) 40 to 200 parts by weight, preferably 50 to 150 parts by weight, more preferably 70 to 120 parts by weight, of at least one unsilanized mineral filler,
(c) 0 to 5 parts by weight of carbon black,
(d) 0.5 to 20 parts by weight, preferably 2 to 10 parts by weight, of at least one peroxide compound, preferably dicumyl peroxide, tert-butyl cumyl peroxide, bis(tert-butylperoxyisopropyl)benzene, di-tert-butyl peroxide, 2,5-dimethylhexane 2,5-dihydroperoxide, 2,5-dimethylhex-3-yne 2,5-dihydroperoxide or dibenzoyl peroxide,
(e) 0 to 15 parts by weight, preferably 1 to 10 parts by weight, of at least one basic silicate, and
(f) 0 to 200 parts by weight, preferably 1 to 100 parts by weight, of at least one customary rubber additive.

The invention preferably also further provides for the use of a vulcanizable composition for production of a vulcanizate in contact with blow-by gas, EGR gas or motor oil comprising blow-by gas constituents, wherein the vulcanizable composition comprises
(a) 100 parts by weight of at least one hydrogenated nitrile rubber,
(b) 40 to 200 parts by weight of at least one calcined kaolin containing 50 to 60 wt %, preferably 55 wt %, of SiO₂ and 35 to 45 wt %, preferably 41 wt %, of Al₂O₃, based on the total amount of component (b), having a pH in water (5 wt % in water) measured according to DIN ISO 787/9 of 6.5±0.5 and a surface area (BET) measured according to ISO 9277 of 8.5 m²/g, or of a mixture of amorphous and cryptocrystalline silica and lamellar kaolinite having a BET surface area of 8 m²/g, an SiO₂ content of 86 wt %, an Al₂O₃ content of 13 wt %, based on the total amount of component (b), and a pH of 6.5,
(c) 0 to 5 parts by weight of carbon black,
(d) 1 to 10 parts by weight of at least one peroxide compound, preferably dicumyl peroxide, tert-butyl cumyl peroxide, bis(tert-butylperoxyisopropyl)benzene, di-tert-butyl peroxide, 2,5-dimethylhexane 2,5-dihydroperoxide, 2,5-dimethylhex-3-yne 2,5-dihydroperoxide, dibenzoyl peroxide, bis(2,4-dichlorobenzoyl) peroxide, tert-butyl perbenzoate, butyl 4,4-di(tert-butylperoxy)valerate or 1,1-bis(tert-butylperoxy)-3,3,5-trimethylcyclohexane,
(e) 1 to 10 parts by weight of at least one sodium aluminium silicate having a pH in water (5 wt % in water) measured according to DIN ISO 787/9 of 11.3±0.7, a content of volatile constituents measured according to DIN ISO 787/2 of 5.5±1.5 and a surface area (BET) measured according to ISO 9277 of 65±15, and
(f) 1 to 100 parts by weight of at least one customary rubber additive.

The invention further provides a process for producing the aforementioned vulcanizable compositions according to the invention, by mixing all components (a), (b), optionally (c), (d), optionally (e) and optionally (f). This can be effected using apparatuses and mixing units known to those skilled in the art.

The sequence in which the components are mixed with one another is not of fundamental importance, but is matched in each case to the mixing units available.

The mixing of components (a), (b), optionally (c), (d), optionally (e) and optionally (f) can be effected here, according to temperature, using the typical mixing systems that are in common use in the rubber industry. It is possible to use i) batchwise mixing units in the form of mixing rolls or internal mixers and ii) continuous mixing units such as mixing extruders.

It has been found to be particularly useful to conduct the mixing of components (a), (b), optionally (c), (d), optionally (e) and optionally (f) at a defined mixer wall temperature in the range from about 30° C. to 40° C., since sufficiently high shear forces can be applied here with the abovementioned mixing units that are in common use in the rubber processing industry to achieve good mixing.

Alternatively, mixing is also possible in suitable units at higher temperatures. In the individual case, it may be necessary first to mix components (a), (b), optionally (c), optionally (e) and optionally (f), and only to mix in the peroxide compound (d) at the very end. This can be accomplished, for example, in the mixing unit in the end piece of a nozzle immediately before the mixture has exited onto the substrate/into the mould.

In practice, after the components according to the invention have been mixed, the vulcanizable compositions are obtained, for example, in the form of what are called “skins”, feed strips or feed slabs, or else in the form of pellets or granules. These can subsequently be pressed in moulds or injection-moulded and are crosslinked under suitable conditions according to the peroxide compounds used.

The invention also provides a process for producing vulcanizates by subjecting the vulcanizable composition according to the invention of the aforementioned type to a vulcanization, i.e. an energy input, especially a thermal treatment.

The energy input can be effected in the form of thermal energy or radiation energy, according to what type of peroxide compound (d) is chosen in the vulcanizable composition.

The production of the vulcanized products by means of thermal treatment is conducted by subjecting the vulcanizable compositions according to the invention to a temperature in the range from preferably 120° C. to 200° C., more preferably from 140° C. to 190° C., in a customary manner in suitable moulds.

In the context of the crosslinking of the vulcanizable composition according to the invention, the peroxide compound (d) leads to free-radical crosslinking between and with the hydrogenated nitrile rubber (a) used.

The invention thus also provides processes for producing a vulcanizate in contact with blow-by gases, comprising the step of vulcanizing a vulcanizable composition, characterized in that the vulcanizable composition comprises
(a) 100 parts by weight of at least one hydrogenated nitrile rubber,
(b) 40 to 200 parts by weight, preferably 50 to 150 parts by weight, more preferably 70 to 120 parts by weight, of at least one unsilanized mineral filler,
(c) 0 to less than 20 parts by weight of carbon black, preferably 0 to less than 10 parts by weight of carbon black, more preferably 0 to 5 parts by weight of carbon black, and
(d) 0.5 to 20 parts by weight of at least one peroxide compound, and
(e) 0 to 15 parts by weight of at least one basic silicate, preferably sodium aluminium silicate.

The invention further also provides vulcanizates obtainable by crosslinking, i.e. vulcanizing, the vulcanizable compositions according to the invention.

The invention further provides for the use of the vulcanizates produced from a vulcanizable composition according to the invention for production of a component, wherein at least the vulcanizate is in contact with blow-by gas or EGR gas or motor oil comprising blow-by gas constituents.

The invention especially provides for the use of the vulcanizates produced from a vulcanizable composition according to the invention for production of a component, wherein at least the vulcanizate is in contact with blow-by gas or EGR gas or motor oil comprising blow-by gas constituents, and the component is a gasket, a belt, a hose or a cable, preferably a gasket, a belt or a hose.

The invention further provides for the use of one the aforementioned embodiments of the vulcanizable compositions according to the invention for production of a vulcanizate in contact with blow-by gas or EGR gas or motor oil comprising blow-by gas constituents.

### EXAMPLES

### Production, Vulcanization and Characterization of the Rubber Compositions

The primary mixing unit used was a Troester WNU3 roll mill with a roller system cooled to 30° C., with rolls having a diameter of 200 mm. The procedure here was to initially charge the hydrogenated nitrile rubber (a) and then to add all further components in the sequence (b), then optionally (c), then (e), then all further rubber additives (f), and finally the peroxide compound (d) (see list of components in Table 1 adduced below). The speed and friction of the roll were controlled here such that stable skins are obtained. After a mixing time of about 5 min, the mixing operation was ended and the product was pulled off the roll as a skin. Subsequently, vulcanization of these skins was undertaken in slab presses at 180° C. for 15 min.

Components used:
Therban® 3406 hydrogenated nitrile rubber (HNBR), ACN content: 34±1.0 wt %, Mooney viscosity ML 1+4 @100° C.: 63±7 MU, residual double bond content: ≤0.9%; commercially available from ARLANXEO Deutschland GmbH
Therban® 3907 hydrogenated nitrile rubber (HNBR), ACN content: 39±1.0 wt %, Mooney viscosity ML 1+4 @100° C.: 70 MU, residual double bond content: ≤0.9%; commercially available from ARLANXEO Deutschland GmbH
Therban® AT 3904 VP hydrogenated nitrile rubber (HNBR), ACN content: 39±1.0 wt %, Mooney viscosity ML 1+4 @100° C.: 40 MU, residual double bond content: ≤0.9%; commercially available from ARLANXEO Deutschland GmbH
Polestar® 200R unsilanized calcined kaolin containing 55 wt % of SiO₂, 41 wt % of Al₂O₃, having a pH of 6.5±0.5 and a surface area (BET) of 8.5 m²/g; commercially available from Imerys
Silfit® Z91 natural mixture of unsilanized corpuscular silica and lamellar kaolinite that has been subjected to a thermal treatment; commercially available from Hoffman Mineral
Vulkasil® N unsilanized reinforcing precipitated silica; commercially available from LANXESS Deutschland GmbH
Aerosil® 200 unsilanized hydrophilic fumed silica having a specific surface area (BET) of 175-225 m²/g; commercially available from Evonik Industries
ZnO aktiv zinc oxide
Maglite® DE magnesium oxide
Aerosil® R7200 methacryloylsilane-treated, structurally modified fumed silica having a specific surface area (BET) of 125-175 m²/g; commercially available from Evonik Industries
Vulkasil® A1 basic sodium aluminium silicate having a pH in water (5 wt % in water) measured according to DIN ISO 787/9 of 11.3±0.7, a content of volatile constituents measured according to DIN ISO 787/2 of 5.5±1.5 and a surface area (BET) measured according to ISO 9277 of 65±15; commercially available from LANXESS Deutschland GmbH
N550 carbon black, Orion Engineered Carbons GmbH
N772 carbon black, Orion Engineered Carbons GmbH
Perkadox® 14-40 di(tert-butylperoxyisopropyl)benzene 40% supported on silica; commercially available from Akzo Nobel Polymer Chemicals BV
Uniplex® 546 trioctyl trimellitate (TOTM); commercially available from LANXESS Deutschland GmbH
Luvomaxx® CDPA 4,4′-bis(1,1-dimethylbenzyl)diphenylamine; commercially available from Lehmann and Voss
Vulkanox® MB2 mixture of 4- and 5-methyl-2-mercaptobenzothiazole; commercially available from LANXESS Deutschland GmbH
Vulkanox® ZMB2/C5 zinc salt of 4- and 5-methyl-2-mercaptobenzimidazole having a density of 1.25 g/cm³ at 25° C. from Lanxess Deutschland GmbH
TAIC triallyl isocyanurate, 70% masterbatch; commercially available from Kettlitz Chemie GmbH & Co KG
TOTM trioctyl trimellitate
Edenor® C18 stearic acid; available from Oleo Solutions
Rhenofit® DDA 70 wt % of diphenylamine derivative (dry liquid) from LANXESS Deutschland GmbH

All figures in “phr” mean parts per hundred of rubber. The sum total of all the elastomer components comprising at least one hydrogenated nitrile rubber corresponds to 100 phr.

Crosslinking density was determined with a moving die rheometer (MDR 2000E), measuring at an angle of 0.5° and an oscillation frequency of 1.7 Hz at 180° C. for 30 minutes.

For the tensile testing, 2 mm sheets were produced by vulcanization of the vulcanizable mixture at 180° C. The dumbbell-shaped test specimens were punched out of these sheets and, according to ASTM D2240-81, the tensile strength (TS), 100 modulus (M100) and elongation at break (E@B) were determined.

Hardness was determined with a durometer to ASTM D2240-81.

### Composition of Acid Mixture I:

| | |
|---|---|
| Water (deionized) | 90.7 vol % |
| Formic acid (98%) | 0.06 vol % |
| Acetic acid (99.9%) | 0.06 vol % |
| Nitric acid (HNO₃) (67.5%) | 0.18 vol % |
| Ethanol (99.8%) | 9 vol % |

### Composition of Acid Mixture II:

| | |
|---|---|
| Formaldehyde-10% (stabilized with 10% | 10.00 wt % |
| methanol) | |
| Water (deionized) | 89.70 wt % |
| Nitric acid (HNO₃) (65%) | 0.18 wt % |
| Formic acid (98-100%) | 0.06 wt % |
| Acetic acid (96%) | 0.06 wt % |

Production was effected by mixing in the sequence specified.

### Examples 1-8

All inventive examples are identified in Tables 1 to 5 which follow with an * after the respective example number.

TABLE 1
Vulcanizable compositions

| | 1 | 2 | 3 | 4* | 5* | 6* | 7 | 8* |
|---|---|---|---|---|---|---|---|---|
| (a) Therban® | 100 | 100 | 100 | 100 | 100 | 100 | 100 | 100 |
| 3406 | | | | | | | | |
| (b) Polestar® | 100 | 100 | 100 | 100 | | 100 | 100 | 100 |
| 200R | | | | | | | | |
| (b) Silfit Z91 | | | | | 100 | | | |
| (b) Vulkasil® | | | | | 20 | 20 | | |
| N | | | | | | | | |
| (b) Aerosil® | | | | | | | | 20 |
| 200 | | | | | | | | |
| Aerosil® | | | | | | | 20 | |
| R7200 | | | | | | | | |
| (c) N550 | 40 | 30 | 20 | 10 | | | | |
| (d) Perkadox® | 8.5 | 8.5 | 8.5 | 8.5 | 8.5 | 8.5 | 8.5 | 8.5 |
| 14-40 | | | | | | | | |
| (e) Vulkasil® | 5 | 5 | 5 | 5 | 5 | 5 | 5 | 5 |
| A1 | | | | | | | | |
| Uniplex 546 | 10 | 10 | 10 | 10 | 10 | 10 | 10 | 10 |
| Luvomaxx | 1.2 | 1.2 | 1.2 | 1.2 | 1.2 | 1.2 | 1.2 | 1.2 |
| CDPA | | | | | | | | |
| Vulkanox® | 0.3 | 0.3 | 0.3 | 0.3 | 0.3 | 0.3 | 0.3 | 0.3 |
| MB2 | | | | | | | | |
| TAIC 70% | 1.5 | 1.5 | 1.5 | 1.5 | 1.5 | 1.5 | 1.5 | 1.5 |

All figures in Table 1 in parts by weight.

The inventive compositions 4*, 5*, 6* and 8* contain, as well as a hydrogenated nitrile rubber (component (a)) and a peroxide compound (component (d)), both an unsilanized mineral filler (component (b)) and less than 20 phr carbon black (component (c)).

Comparative compositions 1, 2 and 3 contain large amounts of carbon black of 20 or more phr.

Comparative composition 7 contains silanized mineral filler (Aerosil® R7200).

TABLE 2
Vulcanization measurement (MDR at 180° C.)

| | | 1 | 2 | 3 | 4* | 5* | 6* | 7 | 8* |
|---|---|---|---|---|---|---|---|---|---|
| S′ min | dNm | 1.8 | 1.6 | 1.5 | 1.3 | 2.3 | 2.2 | 2.0 | 2.7 |
| S′ max | dNm | 36.8 | 34.5 | 31.6 | 28.5 | 35.9 | 33.6 | 44.0 | 40.1 |
| S′ max- | dNm | 35.0 | 32.8 | 30.1 | 27.1 | 33.7 | 31.4 | 42.0 | 37.4 |
| S′ min | | | | | | | | | |
| T95 | s | 425 | 428 | 416 | 417 | 380 | 397 | 343 | 388 |

The vulcanizable compositions according to the invention have comparable vulcanization parameters to the comparative experiments.

Vulcanization was effected in a press at 180° C. Vulcanization was followed by heat treatment at 150° C. for 4 hours.

TABLE 3
Mechanical properties of the vulcanizates

| | | 1 | 2 | 3 | 4* | 5* | 6* | 7 | 8* |
|---|---|---|---|---|---|---|---|---|---|
| Hardness | ShA | 82 | 80 | 77 | 73 | 79 | 79 | 86 | 81 |
| E@B | % | 249 | 291 | 330 | 390 | 380 | 409 | 156 | 381 |
| TS | MPa | 15.2 | 14.7 | 13.7 | 13.1 | 14.4 | 14.6 | 19.4 | 15.0 |
| M100 | MPa | 9.8 | 8.5 | 7.3 | 6.1 | 6.6 | 6.3 | 15.0 | 6.9 |

TABLE 4
Properties of the vulcanizates after ageing in the
abovementioned acid mixture I at 120° C. for 70 hours

| | | 1 | 2 | 3 | 4* | 5* | 6* | 7 | 8* |
|---|---|---|---|---|---|---|---|---|---|
| Increase | % | 13.1 | 11.8 | 12.0 | 12.9 | 3.6 | 4.1 | 24.7 | 4.0 |
| in mass | | | | | | | | | |
| Increase | % | 19 | 18 | 18 | 19 | 7 | 7 | 35 | 7 |
| in | | | | | | | | | |
| volume | | | | | | | | | |
| Hardness | ShA | 58 | 55 | 53 | 50 | 65 | 65 | 69 | 70 |
| delta H | | -24 | -25 | -24 | -23 | -14 | -14 | -17 | -11 |
| E@B | % | 273 | 303 | 365 | 382 | 442 | 441 | 192 | 437 |
| TS | MPa | 14.0 | 12.8 | 13.8 | 10.4 | 13.6 | 11.9 | 14.9 | 13.8 |
| M100 | MPa | 3.1 | 2.4 | 1.9 | 1.3 | 2.1 | 1.9 | 11.0 | 2.4 |
| Change | % | 10 | 4 | 11 | -2 | 16 | 8 | 23 | 15 |
| in E@B | | | | | | | | | |
| Change | % | -8 | -13 | 1 | -21 | -6 | -18 | -23 | -8 |
| in TS | | | | | | | | | |
| Change | % | -68 | -72 | -74 | -79 | -68 | -70 | -27 | -65 |
| in M100 | | | | | | | | | |

The inventive vulcanizates 4*, 5*, 6* and 8*, with values of 382% to 441%, have higher absolute elongation at break (E@B) than the comparative vulcanizates 1-3 and 7 with values of only 192% to 365%. In addition, the inventive vulcanizates 5*, 6* and 8*, after storage in the acid mixture, have a distinct reduction in volume swelling of only 7% compared to the noninventive vulcanizates 1-3 and 7.

TABLE 5
Properties of the vulcanizates after ageing in acid mixture II
at 120° C. for 72 hours

| | | 1 | 2 | 3 | 4* | 5* | 6* | 7 | 8* |
|---|---|---|---|---|---|---|---|---|---|
| Increase | % | 11.2 | 11.1 | 12.0 | 8.9 | 2.4 | 2.8 | 37.4 | 3.3 |
| in mass | | | | | | | | | |
| Increase | % | 18 | 18 | 19 | 14 | 7 | 7 | 53 | 8 |
| in | | | | | | | | | |
| volume | | | | | | | | | |
| Hardness | ShA | 60 | 58 | 55 | 54 | 71 | 71 | 65 | 72 |
| delta H | | -22 | -22 | -23 | -20 | -9 | -8 | -20 | -9 |
| E@B | % | 288 | 330 | 340 | 378 | 439 | 440 | 180 | 429 |
| TS | MPa | 15.2 | 15.1 | 12.8 | 11.5 | 14.1 | 13.6 | 15.4 | 14.8 |
| M100 | MPa | 3.6 | 2.7 | 2.2 | 1.7 | 2.6 | 2.4 | 11.6 | 2.9 |
| Change | % | 16 | 13 | 3 | -3 | 16 | 8 | 15 | 13 |
| in E@B | | | | | | | | | |
| Change | % | 0 | 3 | -7 | -12 | -2 | -7 | -21 | -1 |
| in TS | | | | | | | | | |
| Change | % | -63 | -68 | -70 | -72 | -61 | -62 | -23 | -58 |
| in M100 | | | | | | | | | |

The series of experiments show that vulcanizates according to the invention, after storage in acid mixture II, have a smaller increase in volume and higher elongation at break than vulcanizates comprising silanized mineral fillers or high proportions of carbon black.

TABLE 6
Vulcanizable compositions

| | 9 |
|---|---|
| (a) Therban ® 3907 | 80 |
| (a) Therban ® AT 3904 VP | 20 |
| (b) ZnO aktiv | 2 |
| (b) Maglite ® DE | 2 |
| (c) N772 | 65 |
| (d) Perkadox ® 14-40 | 7.5 |
| TOTM | 5 |
| Edenor ® C18 | 0.5 |
| Rhenofit ® DDA | 1.2 |
| Vulkanox ® ZMB2/C5 | 0.4 |
| TAIC 70% | 1.5 |

All figures in Table 1 in parts by weight.

Comparative composition 9 contains large amounts of carbon black of 20 or more phr and small amounts of only 4 phr of unsilanized mineral filler.

Vulcanization was effected in a press at 180° C. Vulcanization was followed by heat treatment at 150° C. for 4 hours.

TABLE 7
Properties of the vulcanizate after ageing in the
above mentioned acid mixture I at 120° C. for 70 hours

| | | 9 |
|---|---|---|
| Increase in mass | % | 67.6 |
| Increase in volume | % | 81.8 |
| Hardness | ShA | 59 |
| delta H | | −11 |
| E @ B | % | 101 |
| TS | MPa | 10.8 |
| Change in E @ B | % | −63 |
| Change in TS | % | −57 |

Comparative vulcanizate 9 with a large amount of carbon black and small amount of unsilanized mineral filler has much too high an increase in volume of 81.8% and much too low an elongation at break of only 101%.

1. Method of using a vulcanizable composition for production of a vulcanizate in contact with blow-by gas, EGR gas or motor oil comprising blow-by gas constituents, wherein the vulcanizable composition comprises
(a) 100 parts by weight of at least one hydrogenated nitrile rubber, the hydrogenated nitrile rubber having a content of residual double bonds (RDB) of 10% or less,
(b) 40 to 200 parts by weight of at least one unsilanized mineral filler,
(c) 0 to less than 20 parts by weight of carbon black, and
(d) 0.5 to 20 parts by weight of at least one peroxide compound.

2. Method according to claim 1, wherein the hydrogenated nitrile rubber (a) has a content of residual double bonds (RDB) of 7% or less.

3. Method according to claim 1, wherein the content of repeat acrylonitrile units in the hydrogenated nitrile rubber (a) is 10 to 50 wt % based on the total amount of hydrogenated nitrile rubber (a).

4. Method according to claim 1, wherein the hydrogenated nitrile rubber (a), as well as repeat units of at least one unsaturated nitrile and of at least one conjugated diene, contains one or more further copolymerizable monomers in the form of carboxylic acids or carboxylic esters.

5. Method according to claim 1, wherein the unsilanized filler (b) is unsilanized mineral silicatic or oxidic filler.

6. Method according to claim 1, wherein the unsilanized filler (b) is precipitated silica, fumed silica, kaolin, calcined kaolin, diatomaceous earth, Neuburg siliceous earth, calcined Neuburg siliceous earth, feldspar or alumina.

7. Method according to claim 1, wherein the unsilanized filler (b) is unsilanized calcined kaolin having a specific surface area (N₂ surface area) measured according to DIN ISO 9277 of less than 10 m²/g, containing at least 40 wt % of silicate (SiO₂) and at least 10 wt % of alumina (Al₂O₃), based on the total amount of component (b), or a mixture of amorphous and cryptocrystalline silica and lamellar kaolinite having a BET surface area measured according to DIN ISO 9277 of 8 m²/g, an SiO₂ content of 86 wt %, an Al₂O₃ content of 13 wt %, based on the total amount of unsilanized filler (b), and a pH of 6.5.

8. Method according to claim 1, wherein the peroxide compound (d) is dicumyl peroxide, tert-butyl cumyl peroxide, bis(tert-butylperoxyisopropyl)benzene, di-tert-butyl peroxide, 2,5-dimethylhexane 2,5-dihydroperoxide, 2,5-dim ethyl hex-3-yne 2,5-dihydroperoxide, dibenzoyl peroxide, bis(2,4-dichlorobenzoyl) peroxide, tert-butyl perbenzoate, butyl 4,4-di(tert-butylperoxy)valerate or 1,1-bis(tert-butylperoxy)-3,3,5-trimethylcyclohexane.

9. Method according to claim 1, wherein the vulcanizable composition additionally comprises, as component (e), 0 to 15 parts by weight of basic silicate having a pH of more than 7 measured in a 5 wt % aqueous solution according to DIN ISO 787/9.

10. Method according to claim 1, wherein the vulcanizable composition additionally comprises, as component (e), 0 to 15 parts by weight of basic silicate from the group consisting of sodium aluminium silicate and sodium orthosilicate (Na₄SiO₄), sodium metasilicate (Na₂SiO₃), disodium disilicate (Na₂Si₂O₅), and disodium trisilicate (Na₂Si₃O₇).

11. Method according to claim 1, wherein the vulcanizable composition contains
(a) 100 parts by weight of at least one hydrogenated nitrile rubber, the hydrogenated nitrile rubber having a content of residual double bonds (RDB) of 10% or less,
(b) 40 to 200 parts by weight, preferably 50 to 150 parts by weight of at least one unsilanized mineral silicatic or oxidic filler,
(c) 0 to less than 20 parts by weight of carbon black,
(d) 0.5 to 20 parts by weight of at least one peroxide compound, and
(e) 0 to 15 parts by weight of basic silicate having a pH in water (5 wt % in water) measured according to DIN ISO 787/9 of greater than 7.

12. Method according to claim 1, comprising
(a) 100 parts by weight of at least one hydrogenated nitrile rubber, the hydrogenated nitrile rubber having a content of residual double bonds (RDB) of 10% or less,
(b) 40 to 200 parts by weight of at least one calcined kaolin containing 50 to 60 wt % of SiO₂ and 35 to 45 wt % of Al₂O₃, based on the total amount of component (b), having a pH in water (5 wt % in water) measured according to DIN ISO 787/9 of 6.5±0.5 and a surface area (BET) measured according to ISO 9277 of 8.5 m²/g, or of a mixture of amorphous and cryptocrystalline silica and lamellar kaolinite having a BET surface area of 8 m²/g, an SiO₂ content of 86 wt %, an Al₂O₃ content of 13 wt %, based on the total amount of component (b), and a pH of 6.5,
(c) 0 to 5 parts by weight of carbon black,
(d) 1 to 10 parts by weight of at least one peroxide compound,
(e) 1 to 10 parts by weight of at least one sodium aluminium silicate having a pH in water (5 wt % in water) measured according to DIN ISO 787/9 of 11.3±0.7, a content of volatile constituents measured according to DIN ISO 787/2 of 5.5±1.5 and a surface area (BET) measured according to ISO 9277 of 65±15, and
(f) 1 to 100 parts by weight of at least one customary rubber additive.

13. Method of using a vulcanizate produced from a vulcanizable composition for production of a component, wherein at least the vulcanizate is in contact with blow-by gas, EGR gas or motor oil comprising blow-by gas constituents, and wherein the vulcanizable composition wherein the vulcanizable composition comprises
(a) 100 parts by weight of at least one hydrogenated nitrile rubber, the hydrogenated nitrile rubber having a content of residual double bonds (RDB) of 10% or less,
(b) 40 to 200 parts by weight of at least one unsilanized mineral filler,
(c) 0 to less than 20 parts by weight of carbon black, and
(d) 0.5 to 20 parts by weight of at least one peroxide compound.

14. Method according to claim 13, wherein the component in contact with blow-by gas, EGR gas or motor oil comprising blow-by gas constituents is a gasket, a belt, a hose or a cable, preferably a gasket, a belt or a hose.

15. Vulcanizable composition comprising
(a) 100 parts by weight of at least one hydrogenated nitrile rubber, the hydrogenated nitrile rubber having a content of residual double bonds (RDB) of 10% or less,
(b) 40 to 200 parts by weight, preferably 50 to 150 parts by weight of at least one unsilanized mineral filler,
(c) 0 to less than 20 parts by weight of carbon black,
(d) 0.5 to 20 parts by weight of at least one peroxide compound, and
(e) 0 to 15 parts by weight of at least one basic silicate.
